(19) United States
(12) Patent Application Publication
(10) Pub. No.: US 2012/0292076 A1
(43) Pub. Date: Nov. 22, 2012

(54) ADHESIVE-BACKED COAXIAL CABLE

(75) Inventors: Curtis L. Shoemaker, Round Rock, TX (US); Richard L. Simmons, Leander, TX (US); Stephen Paul Leblanc, Austin, TX (US)

(73) Assignee: 3M Innovative Properties Company

(21) Appl. No.: 13/454,569

(22) Filed: Apr. 24, 2012

Related U.S. Application Data
(60) Provisional application No. 61/486,558, filed on May 16, 2011.

(51) Int. Cl. H01B 7/00; H01B 7/18

(52) U.S. Cl. 174/107; 174/102 R

(57) ABSTRACT

According to an exemplary aspect of the present invention, an adhesive-backed coaxial cable includes a conduit portion with a lengthwise bore formed therein. The conduit portion includes coaxial cable structure disposed within the bore. The duct also includes a flange extending lengthwise with the conduit portion. An adhesive layer is disposed on a surface of the flange such that the duct is mountable to a mounting surface via the adhesive layer.

### CROSS-REFERENCE TO RELATED APPLICATION

This application claims the benefit of U.S. Provisional Patent Application No. 61/486,558, filed May 16, 2011, the disclosure of which is incorporated by reference herein in its entirety.

### BACKGROUND OF THE INVENTION

1. Field of the Invention

The present invention is directed to an adhesive backed coaxial cable. In particular, the cable includes at least one flat flange portion

2. Background

Coaxial cables are used as a transmission lines for radio frequency signals to connect electronic equipment together, in applications such as connecting radio transmitters and receivers with their antennas, computer network (Internet) connections, and distributing cable television signals.

Conventional coaxial cable, also known as coax cable, is usually round electrical cable having an inner conductor surrounded by a flexible, tubular dielectric layer, surrounded by a tubular conducting shield and finally overcoated with a protective, insulating jacket. The term coaxial comes from the fact that the inner conductor and the outer shield share the same geometric axis.

Physical and aesthetic challenges exist in distributing coaxial cables in older buildings and structures. These challenges include gaining building access, limited distribution space in riser closets, and space for cable routing and management. In addition, further physical and aesthetic challenges exist in providing coaxial cables within each individual living unit. Conventional coax cables are typically run across the floor between the electronic equipment that it is interconnecting. In order to attach a conventional cable to the wall, they are sometimes stapled to the wall. Stapling the coax to a wall can result in a kinking of the cable shield which could result in the formation of standing waves and reflections within the cable which impair the signal transmission. Alternatively, specialized connection devices can be use to mount the coaxial cable to the wall, but these connection devices must be individually installed which can be cumbersome and time consuming.

### SUMMARY

According to an exemplary aspect of the present invention, an adhesive-backed coaxial cable includes a conduit portion with a lengthwise bore formed therein. The conduit portion includes coaxial cable structure disposed within the bore. The duct also includes a flange extending lengthwise with the conduit portion. An adhesive layer is disposed on a surface of the flange such that the duct is mountable to a mounting surface via the adhesive layer.

The coaxial core structure includes a central inner conductor surrounded by a dielectric layer, wherein the dielectric layer is surrounded by a shielding layer.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 shows a schematic view of an exemplary single family residence having a cable TV network with Data Over Cable Service Interface Specification (DOCSIS) data service utilizing an adhesive backed coaxial cable according to an embodiment of the present invention;

FIGS. 2A and 2B are two isometric views of adhesive backed coaxial cables in accordance with an aspect of the present invention;

FIGS. 3A and 4B are two isometric views of an alternative adhesive backed coaxial cables in accordance with an aspect of the present invention;

FIG. 4 shows a schematic view of an exemplary MDU having a converged in-building network utilizing an adhesive backed coaxial cable according to an embodiment of the present invention; and

FIG. 5 is an isometric views of an alternative adhesive backed coaxial cable in accordance with an aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

As mentioned previously, coaxial cables are frequently used in living units and office buildings to route electrical signals. Adding lengths of coaxial cable in existing structures can be unsightly or require fishing the coaxial cables through or within walls or battling congested conduits. Simplified, reduced labor methods of creating/installing aesthetically pleasing conduits can significantly reduce the cost and complexity to installing new coaxial cable connections in existing structures. The present invention is directed to adhesive-backed coaxial cable design to allow addition of new coax linkage within a living unit of a multi-dwelling unit (MDU), home, or other structure such as a multiple tenant unit (MTU), school, hotel, hospital or other location. The term “living unit” is not limited to a domicile or residence, but can include an office, conference room, hotel room, hospital room, school room or other similar room, whether or not continuously occupied.

Adhesive-backed coaxial cabling allows for cable placement and routing with a reduced or eliminated need for utilizing conventional fasteners, such as staples or screws. In addition, the adhesive-backed coaxial cables described herein can be routed within a living unit with reduced labor costs and complexity, as the need to fish cabling through walls is eliminated.

Coaxial cables are capable of bi-directional carriage of RF signals and can be used to transmit large amounts of data. Cable television signals use only a portion of the bandwidth available over coaxial lines leaving plenty of bandwidth available for other digital services such as

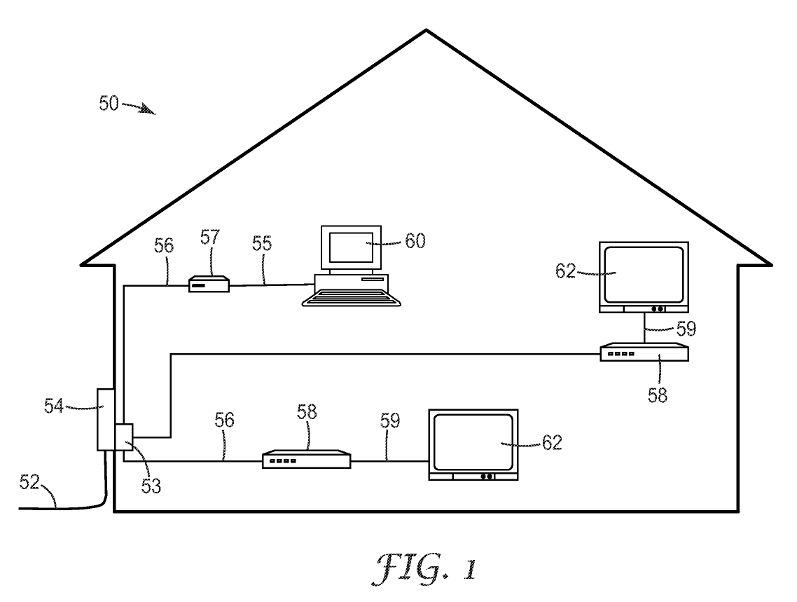

Data Over Cable Service Interface Specification (DOCSIS), Multimedia over Coax Alliance (MoCA) home networking, cable telephony and wireless services. FIG. 1 shows an exemplary coaxial cable fed network within a single family residence or home 50. RF signals enter the home via coaxial feeder cable 52 through a coax network interface device 54. The incoming RF signal can be split into multiple local feeds by a coax splitter 53 and distributed by coaxial distribution cabling 56 throughout the residence 50 to cable modems 57 for broadband internet service or to a cable set-top box 58 for cable television service. Coaxial Jumpers 59 can be used for the final connection from the cable set top box 58 to television 62. Jumpers 55 from the cable modem 57 to the computer 60 can be by coaxial cable, or typically, by Cat5e cable.

When a cable TV system is installed into a existing home, it can be inconvenient to hide the coaxial distribution cables, and routing free coaxial cables along the floor or attaching them to the wall with conventional fasteners or staples can be unsightly. Thus, an adhesive backed coaxial cable such as is described herein can provide an easy to install more aesthetically pleasing coaxial cable network.

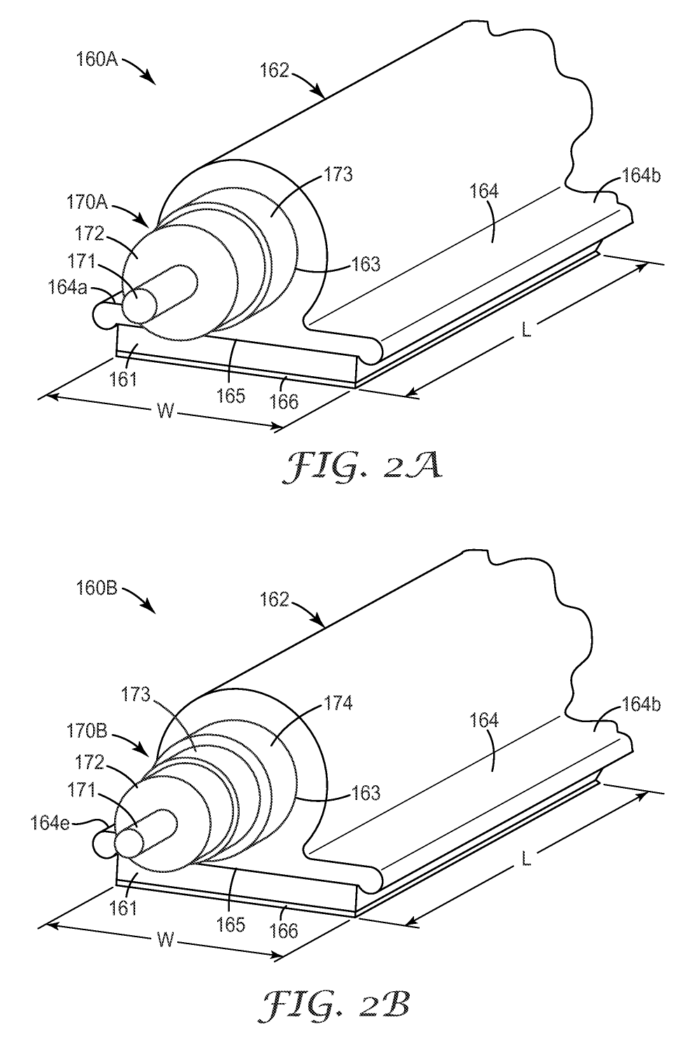

Exemplary adhesive-backed coaxial cable 160A, 160B are described in further detail with respect to FIGS. 2A and 2B.

In one exemplary aspect, an adhesive-backed coaxial cable 160A is shown in FIG. 2A. Adhesive-backed coaxial cable 160A includes a conduit portion 162 having a bore 163 extending longitudinally therethrough. Adhesive-backed coaxial cable 160A is an elongated structure that may have a length (L) of up to several tens of meters (depending on the application) or even hundreds of meters. The bore 163 is sized to accommodate one or more coaxial lines disposed therein. In this aspect, a coaxial core 170A can be accommodated in the bore of the conduit portion of the adhesive-backed coaxial cable. The coaxial core comprises a central inner conductor 171 surrounded by a dielectric layer 172. The inner conductor can be a single conductive element or wire or a plurality of smaller gauge bare metal wires surrounded by the dielectric layer. Shielding layer 173 can be disposed over the dielectric layer 172. The shielding layer can help ground the adhesive-backed coaxial cable, help control the impedance of the cable as well as prevent electromagnetic interference or emissions from the cable. The shielding layer can be in the form of a metal foil or a braid or woven metal layer or a combination thereof which is disposed over the dielectric layer wrapped around the first inner conductor.

While conduit portion 162 can have a generally circular cross-section, in alternative embodiments it may have another shape, such as a rectangle, square, or flat ribbon cross-section in the case when it is used with either a twinax core or a multi-ax core structure.

In one aspect, adhesive-backed coaxial cable 160A is a continuous structure formed from a polymeric material such as polyvinyl chloride (PVC), making it flexible and robust. In another aspect, adhesive-backed coaxial cable 160A can comprise an exemplary material such as a polyurethane elastomer, e.g., Elastollan 1185A10FHF. In yet another aspect, adhesive-backed coaxial cable 160A can comprise a polyolefin material that optionally includes one or more flame retardant additives. As such, adhesive-backed coaxial cable 160A can be guided and bent around corners and other structures without cracking or splitting. Adhesive-backed coaxial cable 160A can be continuously formed by extruding the conduit portion around the coaxial core structure.

Adhesive-backed coaxial cable 160A also includes a flange 164 or similar flattened portion to provide support for the adhesive-backed coaxial cable 160A as it is installed on or mounted to a wall or other mounting surface, such as a floor, ceiling, or molding. In most applications, the mounting surface is generally flat. The mounting surface may have texture or other structures formed thereon. In other applications, the mounting surface may have curvature, such as found with a pillar or column. Flange 164 extends along the longitudinal axis of the duct. Exemplary adhesive-backed coaxial cable 160A includes a double flange structure, with flange portions 164a and 164b, positioned (in use) below the centrally positioned conduit portion 162. In an alternative aspect, the flange can include a single flange portion. In alternative applications, a portion of the flange can be removed for in-plane and out-of-plane bending.

In a preferred aspect, flange 164 includes a rear or bottom surface 165 that has a generally flat surface shape. This flat surface provides a suitable surface area for adhering the adhesive-backed coaxial cable 160A to a mounting surface, a wall or other surface (e.g., dry wall or other conventional building material) using an adhesive layer 161. For example, in a preferred aspect of the present invention, the adhesive layer 161 comprises a pressure sensitive adhesive, such as a transfer adhesive or double-sided tape, disposed on all or at least part of bottom surface 165. These types of adhesives do not exhibit macroscopic flow behavior upon application to a mounting surface and thus do not substantially change dimensions upon application to the mounting surface. In this manner, the aesthetic quality of the applied duct is maintained. Alternatively, adhesive layer can comprise an epoxy.

In one aspect, bottom surface 165 is backed with an adhesive layer 161 having a removable liner 166. In use, the liner can be removed and the surface 165 can be applied to a mounting surface via adhesive 161. For example, an adhesive such as a factory applied 3M™ VHB™ Tape 4941F can be utilized as adhesive layer 161. In other alternative aspects, adhesive layer 161 comprises a repositionable adhesive or a removable adhesive, such as a stretch release adhesive. By “removable adhesive,” it is meant that the adhesive-backed coaxial cable 160A can be mounted to a mounting surface (preferably, a generally flat surface, although some surface texture and/or curvature are contemplated) so that the adhesive-backed coaxial cable 160A remains in its mounted state until acted upon by an installer/user to remove the duct from its mounted position. Even though the duct is removable, the adhesive is suitable for those applications where the user intends for the duct to remain in place for an extended period of time. Suitable removable adhesives are described in more detail in PCT Publication No. WO 2011/129972, incorporated by reference herein in its entirety. Thus, high speed communications media cabling can be securely routed within the living unit without the need for using fasteners, such as staples and screws, as the adhesive backing allows for flush mounting to the wall or mounting surface, reducing clutter and damage while improving the aesthetics of the installed cable.

In a further alternative aspect, an alternative adhesive-backed coaxial cable 160B is shown in FIG. 2B, which includes a conduit portion 162 having a bore 163 extending longitudinally therethrough. The bore 163 is sized to accommodate one or more coaxial core structures 170B disposed therein. In this aspect, a coaxial core 170B can be a traditional coaxial cable, such as P LMR-300 Coax Cable available from Times Microwave Systems (Wallingford, Conn.) and distributed by TESSCO Technologies Incorporated (Hunt Valley, Md.), that can be accommodated in the bore of the conduit portion of the adhesive-backed coaxial cable. The coaxial core structure 170B includes a central inner conductor 171 surrounded by a dielectric layer 172. The inner conductor can be a single conductive element or wire or a plurality of smaller gauge bare metal wires surrounded by the dielectric layer. Shielding layer 173 can be disposed over the dielectric layer 172 and an insulating jacket 174 can be disposed over the shielding layer.

Adhesive-backed coaxial cable 160B also includes a flange 164 or similar flattened portion to provide support for the adhesive-backed coaxial cable 160B as it is installed on or mounted to a wall or other mounting surface, such as those described above. The flange extends along the longitudinal axis of the duct. Exemplary adhesive-backed coaxial cable 160B includes a double flange structure, with flange portions 164a and 164b, positioned (in use) below the centrally positioned conduit portion. In an alternative aspect, the flange can include a single flange portion. In alternative applications, a portion of the flange can be removed for in-plane and out-of-plane bending

In a preferred aspect, the flange 164a, 164b includes a rear or bottom surface 165 that has a generally flat surface shape. This flat surface provides a suitable surface area for adhering the adhesive-backed coaxial cable 160B to a mounting surface, a wall or other surface (e.g., dry wall or other conventional building material) using an adhesive layer 161. The adhesive layer 161 may comprise any of the adhesive materials described previously.

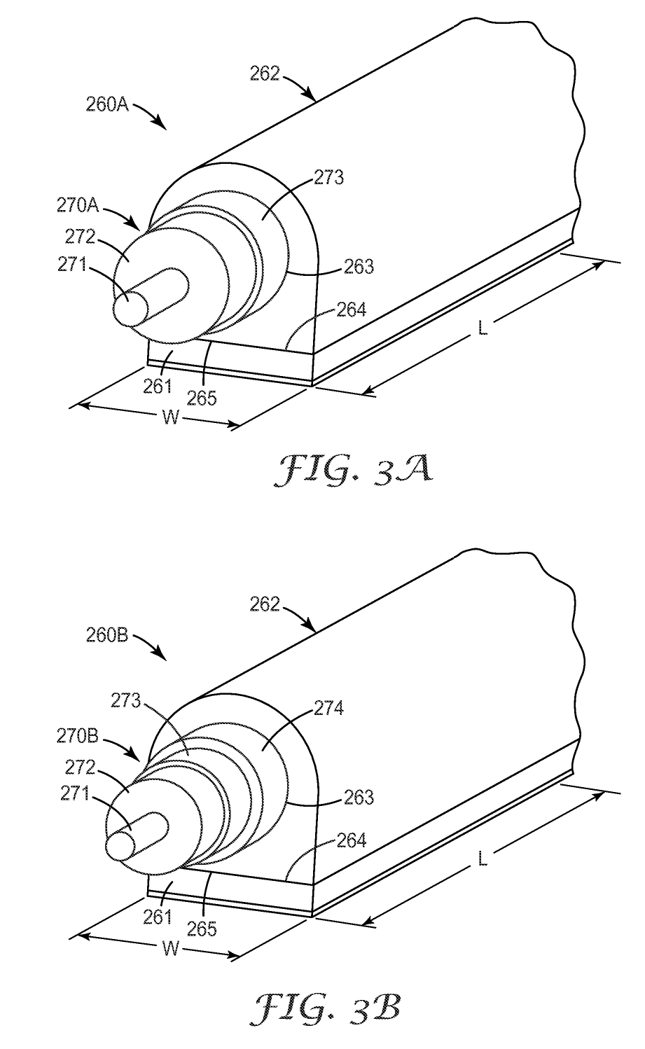

In a further alternative aspect, an alternative adhesive-backed coaxial cable 260A is shown in FIG. 3A, which includes a conduit portion 262 having a bore 263 extending longitudinally therethrough. The bore 263 is sized to accommodate one or more coaxial core structures 270A disposed therein. In this aspect, a coaxial core 270A can be a traditional coaxial cable that is accommodated in the bore of the conduit portion of the adhesive-backed coaxial cable. The coaxial core structure 270A includes a central inner conductor 271 surrounded by a dielectric layer 272. The inner conductor can be a single conductive element or wire or a plurality of smaller gauge bare metal wires surrounded by the dielectric layer. Shielding layer 273 can be disposed over the dielectric layer 272.

Adhesive-backed coaxial cable 260A also includes a flange 264 or similar flattened portion to provide support for the adhesive-backed coaxial cable 260A as it is installed on or mounted to a wall or other mounting surface, such as those described above. The flange extends along the longitudinal axis of the duct. Exemplary adhesive-backed coaxial cable 260A includes a single flange structure centrally positioned below conduit portion 262.

In a preferred aspect, flange 264 includes a rear or bottom surface 265 that has a generally flat surface shape. This flat surface provides a suitable surface area for adhering the adhesive-backed coaxial cable 260A to a mounting surface, a wall or other surface (e.g., dry wall or other conventional building material) using an adhesive layer 261. The adhesive layer 261 may comprise any of the adhesive materials described previously.

FIG. 3B shows an alternative adhesive-backed coaxial cable 260B which is similar coaxial cable 260A of FIG. 3A except that a different coaxial core structure 270B is disposed within the bore 263 of conduit portion 262. The coaxial core structure 270B includes a central inner conductor 271 surrounded by a dielectric layer 272. The inner conductor can be a single conductive element or wire or a plurality of smaller gauge bare metal wires surrounded by the dielectric layer. Shielding layer 273 can be disposed over the dielectric layer 272 and an insulating jacket 274 can be disposed over the shielding layer. Adhesive layer 261 is attached to the bottom surface 265 of flange 264.

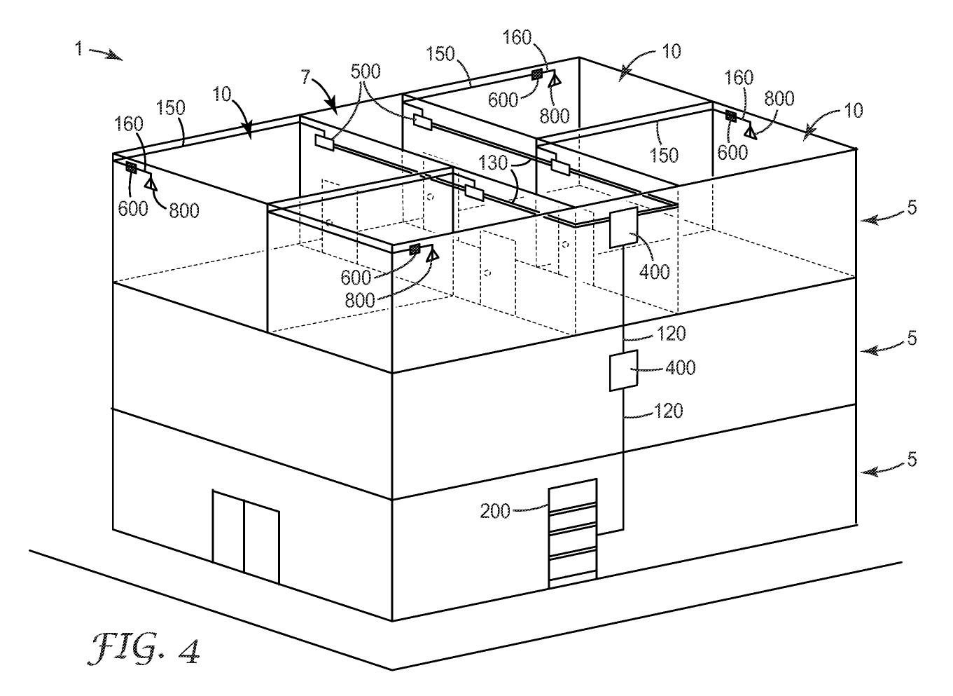

As mentioned previously, coaxial cables can be used to interconnect radio transmitters and receivers with antennas as part of an in-building wireless network. In-Building Wireless (IBW) Distributed Antenna Systems (DASs) are utilized to improve wireless coverage within buildings and related structures. Conventional DASs use strategically placed antennas or leaky coaxial cable (leaky coax) throughout a building to accommodate radio frequency (RF) signals in the 300 MHz to 6 GHz frequency range. Conventional RF technologies include TDMA, CDMA, WCDMA, GSM, UMTS, PCS/cellular, iDEN, and many others. Additional wireless signals which use an in-building wireless network can also include telemetry, WiFi, and public safety signals. FIG. 4 shows an exemplary multi-dwelling unit (MDU) 1 having an exemplary wireless network solution installed therein. The MDU includes four living units 10 on each floor 5 within the building with two living units located on either side of a central hallway 7.

Coax feeds (not shown) bring the RF or wireless signals into the building from nearby wireless towers or base stations. The coax feeds are fed into a main distribution facility or main distribution rack 200 in the basement or equipment closet of the MDU. The main distribution rack 200 organizes the signals coming into the building from external networks to the centralized active equipment for the in building wireless network. Power mains and backup power can also be distributed through the main distribution rack. In many DAS systems, the RF signal is converted to an optical signal for ease of distribution throughout the building. Optical fiber and power cable management which supports the wireless network can be managed by the main distribution rack. In addition the main distribution rack may have modules to organize and manage the wired communication network. The main distribution rack(s) 200 can hold one or more equipment chassis as well as telecommunication cable management modules. Exemplary equipment which can be located on the rack in the main distribution facility can include, for example, a plurality of RF signal sources, an RF conditioning drawer, a DAS hub, a power distribution equipment, and DAS remote management equipment. Exemplary telecommunication cable management modules can include, for example, a fiber distribution hub, a fiber distribution terminal or a patch panel.

Riser cables or trunk cables 120 run from the equipment rack 200 in the main distribution facility to the area junction boxes 400 located on each floor 5 of the MDU 1. The area junction box provides the capability to aggregate horizontal fiber runs and optional power cabling on each floor. At the area junction box, trunked cabling is broken out in to horizontal cabling structures containing optical fibers or other communication cables and power cables which are distributed within the MDU by horizontal cabling 130. In an exemplary aspect the horizontal cabling can utilize an adhesive-backed cabling duct designs. Exemplary adhesive-backed horizontal cabling duct designs are described in U.S. Patent Publication Nos. 2009-0324188 and 2010-0243096, incorporated by reference herein in their entirety.

A point of entry box 500 is located in the central hallway at each living unit to split off power and optical fibers supporting the wireless network from the horizontal cabling 130 to be used within a given living unit 10.

The cables enter the living unit though a second point of entry box (not shown) within the living unit 10. The point of entry box in the living unit can be similar to point of entry box 500 or it can be smaller because fewer communication lines or cables are typically handled in the second point of entry box in the living unit. The cables entering the living unit through the second point of entry box feed remote radio socket 600.

The optical fibers and power cables which feed the remote radio socket can be disposed in wireless duct 150. Wireless duct 150 can be adhesively mounted to the wall or ceiling within the MDU. Exemplary wireless ducts are described in U.S. Patent Publication Nos. 2009-0324188 and 2010-0243096, incorporated by reference herein in their entirety.

The remote radio socket 600 can include remote repeater/radio electronics to facilitate a common interface between the active electronics and the structured cabling system. The remote radio socket facilitates plugging in the remote radio electronics which convert the optical RF to electrical signals and further distributes this to the distributed antennas 800 for radiation of the analog RF electrical signal for the IBW distribution system.

The distributed antennas 800 can be connected to the remote radio socket 600 by a short length of adhesive backed coaxial cable 160.

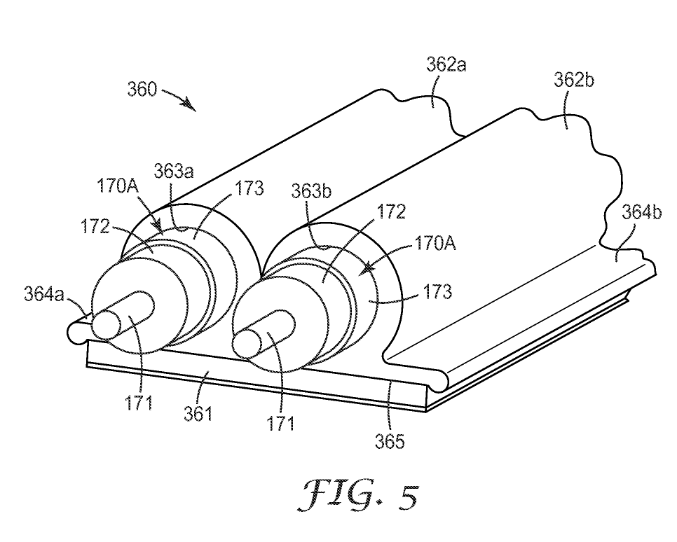

In a further alternative aspect, an alternative adhesive-backed coaxial cable 360 is shown in FIG. 5, which includes a pair of conduit portions 362a, 362b having a bores 363a, 363b extending longitudinally therethrough. Coaxial cable 360 can be used to interconnect a remote radio socket to an antenna when two coaxial connections are needed to feed the RF signals to and from the antenna.

The bores 363a, 363b are sized to accommodate a coaxial core structures 170A within each bore. The coaxial core structures 170A include a central inner conductor 171 surrounded by a dielectric layer 172. The inner conductor can be a single conductive element or wire or a plurality of smaller gauge bare metal wires surrounded by the dielectric layer.

Adhesive-backed coaxial cable 360 also includes a flange or similar flattened portion to provide support for the adhesive-backed coaxial cable 360 as it is installed on or mounted to a wall or other mounting surface, such as those described above. The flange extends along the longitudinal axis of the duct. Exemplary adhesive-backed coaxial cable 360 includes a double flange structure, with flange portions 364a and 364b, positioned (in use) below the pair of conduit portions. In an alternative aspect, the flange can include a single flange portion. In alternative applications, a portion of the flange can be removed for in-plane and out-of-plane bending.

In a preferred aspect, the flange 364a, 364b includes a rear or bottom surface 365 that has a generally flat surface shape. This flat surface provides a suitable surface area for adhering the adhesive-backed coaxial cable 360 to a mounting surface, a wall or other surface (e.g., dry wall or other conventional building material) using an adhesive layer 361. The adhesive layer 361 may comprise any of the adhesive materials described previously.

The adhesive backed coaxial cable described herein can be utilized for providing all manner of coax cable connections that may be required within a living unit or home. The system has a low profile and minimally impacts the aesthetics of the interior of the living unit, while providing protection for the communication lines from mechanical and environmental damage.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. An adhesive backed coaxial cable, comprising:
a conduit portion having a lengthwise bore formed therein, the conduit portion including a coaxial core structure contained within the bore;
a flange extending lengthwise with the conduit portion; and
an adhesive layer is disposed on a surface of the flange such that the duct is mountable to a mounting surface via the adhesive layer.

2. The coaxial cable of claim 1, wherein the coaxial core structure comprises a central inner conductor surrounded by a dielectric layer, wherein the dielectric layer is surrounded by a shielding layer.

3. The coaxial cable of claim 2, the coaxial core structure further comprising an insulating jacket formed over the shielding layer.

4. The coaxial cable of claim 1, wherein the duct is formed from a flexible material such that it can be bent around a curved surface.

5. The coaxial cable of claim 1, wherein the adhesive layer comprises a pressure sensitive adhesive.

6. The coaxial cable of claim 1, wherein the adhesive layer comprises a repositionable adhesive.

7. The coaxial cable of claim 2, wherein the conduit portion forms the jacket of the coaxial cable.

8. The coaxial cable of claim 1, wherein the cable comprises a single flange.

9. The coaxial cable of claim 1, wherein the cable comprises a double flange structure.

10. The coaxial cable of claim 1, wherein the coaxial core structure comprises a twin coaxial cable.

11. The coaxial cable of claim 1, wherein the coaxial cable comprises a plurality of conduit portions and wherein each of the plurality of conduits includes one coaxial core structure contained within the bore of each of the plurality of conduits.
